(19) United States
(12) Patent Application Publication
(10) Pub. No.: US 2010/0220110 A1
(43) Pub. Date: Sep. 2, 2010

(54) IMAGE SIGNAL PROCESSING APPARATUS AND METHOD OF CONTROLLING THE SAME

(76) Inventor: Takahiro Kimura, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/689,879

(22) Filed: Jan. 19, 2010

(30) Foreign Application Priority Data
Mar. 2, 2009 (JP) 2009-048118

(51) Int. Cl. G09G 5/02; G08B 5/00; G08C 19/00

(52) U.S. Cl. 345/593; 340/691.6; 340/825.69

(57) ABSTRACT

According to one embodiment, a display, a display color set module and an image quality adjustment module are provided. The display color set module is configured to set a color limited display state according to an operation signal for selecting, the color limited display state being an off-state of at least one of color components of red, green and blue for a displaying full-color image signal. The image quality adjustment module is configured to uniquely adjust a color limited image signal in the state of the color limited display state according to an operation signal for adjustment.

### CROSS-REFERENCE TO RELATED APPLICATIONS

This application is based upon and claims the benefit of priority from Japanese Patent Application No. 2009-048118, filed Mar. 2, 2009, the entire contents of which are incorporated herein by reference.

### BACKGROUND

1. Field

One embodiment of the invention relates to an image signal processing apparatus and a method of controlling the image signal processing apparatus, and more particularly, to an improvement in color display and adjustment functions.

2. Description of the Related Art

Television broadcast receivers are provided with image quality adjustment functions. For the image quality adjustment functions, there are a luminance adjustment and a color adjustment. Most of these adjustment functions are to make overall adjustments in user's desired luminance, contrast, tint, color density, etc, in a full-color image signal display state. For techniques for adjusting image quality for color display, there is one described in, for example, Jpn. Pat. Appln. KOKAI Publication No. 11-305709. In Jpn. Pat. Appln. KOKAI Publication No. 11-305709, only a blue component alone is supplied to a cathode ray tube by a switching circuit to provide a blue screen state and in this state any of cyan (C), magenta (M), white (W), and blue (B) signals is further selectively input. Then, luminances in respective YC, YM, YW, and YB states are measured and tint and color density are adjusted such that the luminances in the respective states are equal to one another. To make this adjustment, a unique measuring apparatus, computer, etc., are mounted on a cathode ray tube apparatus and then work is conducted.

Recently, there has been a demand for an adjustment to an image with a single color of blue by user preference. In such a case, it is desired adjust image quality, such as user's desired tint and color density, in a single color state but there are no effective techniques. Particularly, those users (specialists, artists, etc.) who have a keen sense of color may desire further minute adjustments in tint and color density.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block configuration diagram of an apparatus according to one embodiment of the present invention;

FIG. 2 is an illustrative diagram showing an external appearance of a remote control in FIG. 1;

FIGS. 3A to 3D are illustrative diagrams showing states of screens for when color density and tint are adjusted in the apparatus in the present invention;

FIGS. 4A to 4G are diagrams showing exemplary images in various color limited display states in the apparatus in the present invention; and

FIG. 5 is a diagram exemplifying a screen for when a color limited set value is checked in the apparatus in the present invention.

### DETAILED DESCRIPTION

Various embodiments according to the invention will be described hereinafter with reference to the accompanying drawings.

In one aspect of the present invention, an image signal processing apparatus and a method of controlling the image signal processing apparatus are provided which can arbitrarily set display states of various single-color images and can independently adjust image quality in every single-color image.

According to one embodiment of the present invention, a display color set module is configured set a color limited display state according to an operation signal for selecting, the color limited display state being an off state of at least one of color components of red, green, and blue for a full-color image signal to be output for displaying. An image quality adjustment module is configured to uniquely adjust a color limited image signal in the color limited display state according to an operation signal for adjustment.

According to the embodiment of the present invention, unique and intensive adjustments in tint, density, etc., can be made to a color limited image signal in a color limited display state. As a result, image quality can be provided which is adapted to user preferences more and in which tint, color density, etc., are adjusted with high accuracy. According to an image, an appropriate color can be obtained for a color of an image to which attention is particularly paid.

More specific description will be made below.

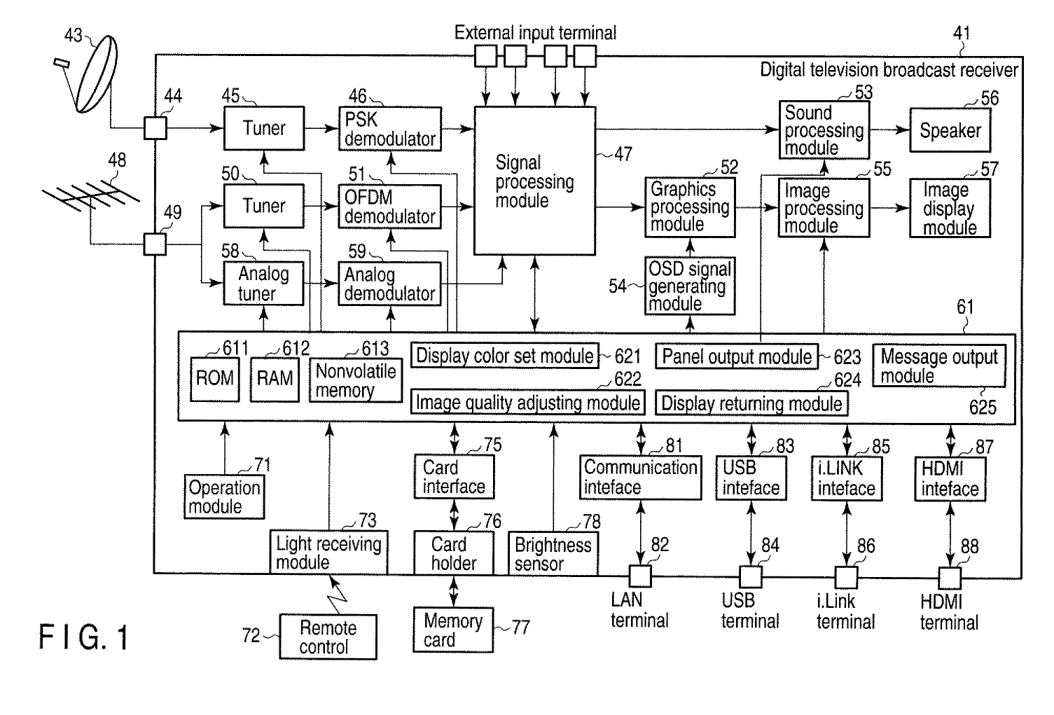

First, a summary of a broadcast receiver to which the present invention is applied will be described. FIG. 1 shows a principal signal processing system of a digital television broadcast receiver 41. Specifically, a satellite digital television broadcast signal received by an antenna 43 for receiving digital broadcasts (BS/CS) signal is supplied to a tuner 45 for satellite digital broadcasts through an input terminal 44, whereby a broadcast signal of a desired channel is selected.

The broadcast signal selected by the tuner 45 is supplied to a phase-shift keying (PSK) demodulator 46 and demodulated to a digital image signal and a digital sound signal. Then, the digital image and sound signals are output to a signal processing module 47.

A terrestrial digital television broadcast signal received by an antenna 48 for receiving terrestrial digital broadcasts is supplied to a tuner 50 for terrestrial digital broadcasts through an input terminal 49, whereby a broadcast signal of a desired channel is selected.

The broadcast signal selected by the tuner 50 is supplied to an orthogonal frequency division multiplexing (OFDM) demodulator 51 and demodulated to a digital image signal and a digital sound signal. Then, the digital image and sound signals are output to the signal processing module 47.

An analog tuner 58 which receives terrestrial analog signals is also provided. A signal received by the analog tuner 58 is demodulated by an analog demodulator 59 and the demodulated signals are output to the signal processing module 47.

The signal processing module 47 selectively performs predetermined digital signal processing on the digital image and sound signals supplied from the PSK demodulator 46, the digital image and sound signals supplied from the OFDM demodulator 51, the image and sound signals supplied from the analog demodulator 59, and further image and sound signals from line input terminals and outputs the processed signals to a graphics processing module 52 and a sound processing module 53.

Among them, the graphics processing module 52 has a function of superimposing an OSD signal generated by an on-screen display (OSD) signal generating module 54, onto the digital image signal supplied from the signal processing module 47 and outputting the superimposed signal. Also, the graphics processing module 52 can selectively output the output image signal from the signal processing module 47 and the output OSD signal from the OSD signal generating module 54 or can output the two output signals in a multiplexed manner or in combination in order to configure a half of a screen.

The digital image signal output from the graphics processing module 52 is supplied to an image processing module 55. The image processing module 55 converts the input digital image signal to an analog image signal in a format displayable on an image display module 57 and outputs the analog image signal to the image display module 57 to display an image.

The sound processing module 53 converts the input digital sound signal to an analog sound signal in a format reproducible by a speaker 56 and outputs the analog sound signal to the speaker 56 to reproduce sound.

In the digital television broadcast receiver 41, overall control of all operations including the above-described various receiving operations is performed by a control module 61.

The control module 61 includes a central processing unit (CPU), etc. When the control module 61 receives operation information from an operation module 71 or receives operation information from a remote control 72 through a light receiving module 73, the control module 61 performs overall control of each module such that the operation content is reflected in the apparatus.

In this case, the control module 61 mainly uses a read-only memory (ROM) 611 which stores a control program executed by the CPU, a random access memory (RAM) 612 which provides the CPU with a work area, and a nonvolatile memory 613 which stores various setting information, control information, etc.

The control module 61 is connected, through a card interface 75, to a card holder 76 into which a first memory card 77 can be inserted. Therefore, the control module 61 can perform transmission and reception of information with the first memory card 77 inserted into the card holder 76, through the card interface 75. Though not shown, the control module 61 may be connected, through another card interface, to a card holder into which a second memory card can be inserted.

The control module 61 is connected to a brightness sensor 78. Therefore, the control module 61 can obtain ambient brightness information and, for example, automatically control the brightness of a screen.

The control module 61 is connected to a first LAN terminal 82 through a communication interface 81. Therefore, the control module 61 can perform transmission and reception of information with a LAN-compatible hard disk drive (HDD) connected to the first LAN terminal 82, through the communication interface 81. In this case, the control module 61 has a Dynamic Host Configuration Protocol (DHCP) server function and thus assigns an Internet Protocol (IP) address to the LAN-compatible HOD connected to the first LAN terminal 82 to control the LAN-compatible HOD. Though not shown, the control module 61 may be connected to a second LAN terminal through another communication interface.

The control module 61 is connected to a USB terminal 84 through a USB interface 83. Therefore, the control module 61 can perform transmission and reception of information with a device connected to the USB terminal 84, through the USB interface 83.

The control module 61 is connected to an i.Link (registered trademark) terminal 86 through an i.Link (registered trademark) interface 85. Therefore, the control module 61 can perform transmission and reception of information with a device connected to the i.Link (registered trademark) terminal 86, through the i.Link (registered trademark) interface 85.

The control module 61 can perform transmission and reception of information with a device connected to a High-Definition Multimedia Interface (HDMI) terminal 88, through an HDMI interface 87 which conforms to the HDMI standard.

The control module 61 further includes a display color set module 621 which arbitrarily sets a display state in which any one of a plurality of color components contained in a full-color image signal is cut out; and an image quality adjustment module 622 which makes a unique image-quality adjustment to a color limited image signal in a state in which the signal is displayed with a limited single color. In addition, the control module 61 includes a panel output module 623 which displays an adjustment screen upon image quality adjustment. An image quality adjustment operation in this state will be described in detail later. The control module 61 further includes a display returning module 624 which allows the apparatus to return to a full-color image signal display state when a predetermined period of time has elapsed after an adjustment has been completed; and a message output module 625 which outputs an alert when the operation setting is irregular.

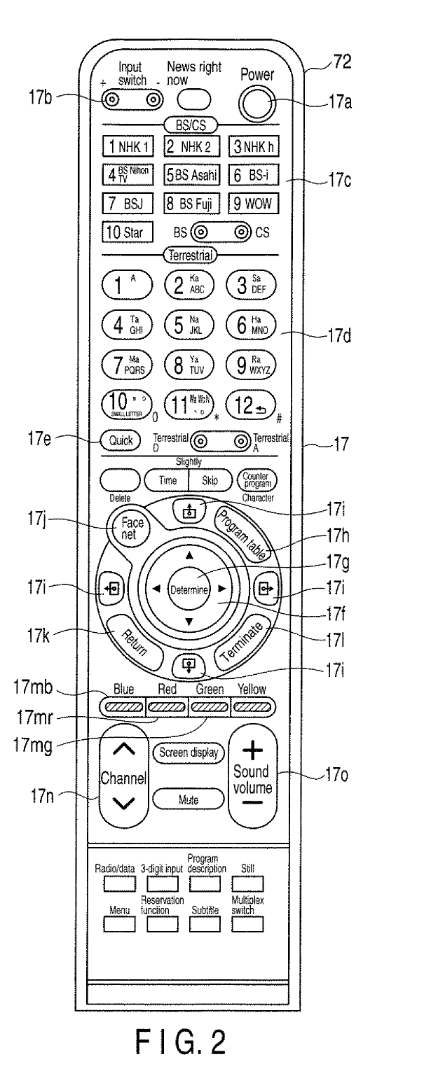

FIG. 2 shows an external appearance of the remote control 72. The remote control 72 is mainly provided with a power key 17a, an input switching key 17b, direct tuning keys 17c for satellite digital broadcast channels, direct tuning keys 17d for terrestrial broadcast channels, a quick key 17e, a cursor key 17f, a determination key 17g, a program table key 17h, page switching keys 17i, a face net (navigation) key 17j, a return key 17k, a terminate key 17l, color keys in blue, red, and green 17 mb, 17 mr, and 17 mg, a channel up and down key 17n, a sound volume adjustment key 17o, etc.

When the program table key 17h is pressed, a program table is displayed. When the terminate key 17l is pressed, the apparatus returns to an off-air (display of an image of a channel currently received) state.

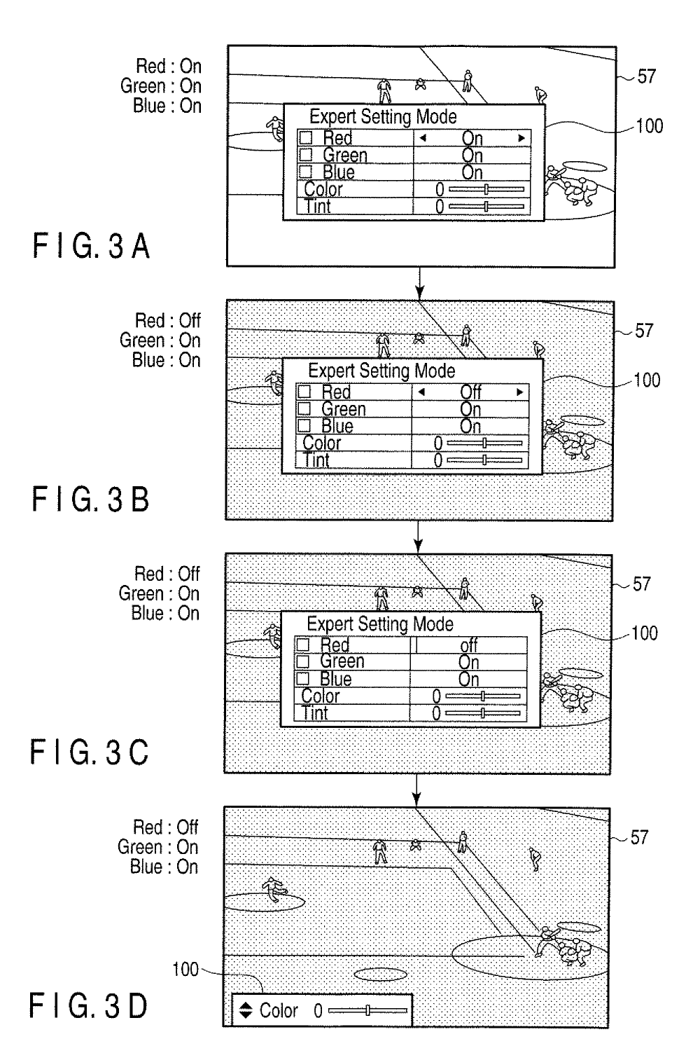

FIG. 3A shows an example in which a full-color image signal containing a plurality of color components of red, green, and blue is displayed on the image display module 57 and an adjustment panel 100 to adjust the “color” (density) and “tint” items for each color is displayed in order to be superimposed on an image. The case of FIG. 3A shows a state in which a red setting is selected. The color and item to be adjusted can be selected by a selection operation signal which is output by operating the cursor key 17f on the remote control 72.

FIG. 3B shows a state in which a color image signal with red being set to off, green being set to on, and blue being set to on is displayed on the image display module 57.

FIG. 3C shows a state in which a color image signal with red being set to off, green being set to on, and blue being set to on is displayed on the image display module 57 and the “color” (density) adjustment item for each color is selected and adjusted.

Likewise, the “tint” item can also be adjusted. FIG. 30 shows a state in which a color image signal with red being set to off, green being set to on, and blue being set to on is displayed on the image display module 57 and the “tint” is adjusted. This adjustment can also be made by outputting an adjustment operation signal by operating the cursor key 17l or the up and down key 17n and the determination key 17g on the remote control 72.

After a predetermined period of time has elapsed after an adjustment by an operation signal for adjustment has been completed, the apparatus returns to a full-color image signal display state by the display returning module 624.

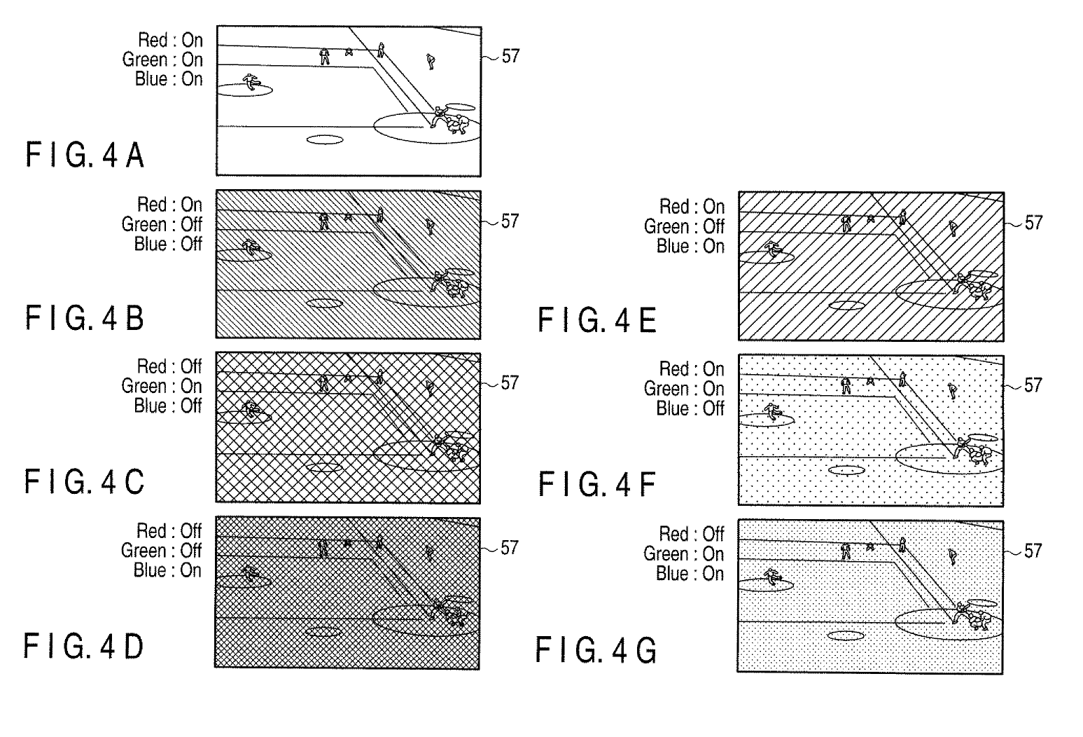

FIG. 4A shows a state in which a full-color image signal containing a plurality of color components of red, green, and blue is displayed on the image display module 57. The image display module 57 is a liquid crystal display. For the image display module 57, an organic electroluminescent display, a plasma display, etc., may be used.

FIG. 43 shows a state in which a state of displaying only a red component is set. FIG. 4C shows a state in which a state of displaying only a green component is set. FIG. 43 shows a state in which a state of displaying only a blue component is set. FIG. 4E shows a state in which a state of displaying red and blue components is set. FIG. 4F shows a state in which a state of displaying red and green components is set. FIG. 4G shows a state in which a state of displaying green and blue components is set.

The above-described setting operations can be performed by, for example, directly operating the blue, red, green, and yellow color keys 17 mb, 17 mr, and 17 mg on the remote control 72. The display color set module 621 responds to an operation signal and determines a display color.

After a predetermined period of time has elapsed after an adjustment by the image quality adjustment module 622 has been completed, the display returning module 624 allows the apparatus to return to a full-color image signal display state. When the setting shifts, by an operation, to one in which all the color components of red, green, and blue are non-display, the display color set module 621 does not perform this setting. Also, when the setting performed by the display color set module 621 shifts, by an operation, to one in which all the color components of red, green, and blue are non-display, the message output module 625 displays a message indicating that this setting is invalid.

The setting performed by the display color set module 621 can be changed by operating the red, green, and blue color keys 17 mb, 17 mr, and 17 mg on the remote control 72. By a repetitive operation of one same key, a single-color image signal corresponding to the key can repeat on and off.

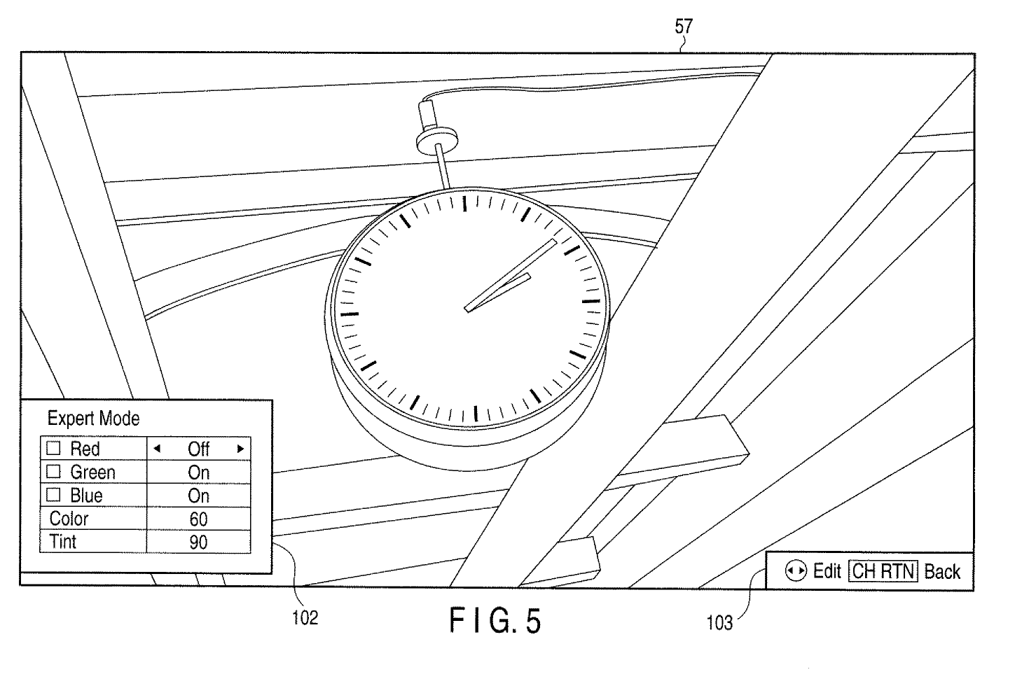

FIG. 5 shows a state of a screen for when, for example, a color mode (expert mode) is selected on a menu screen. When a color setting mode (expert setting mode) is selected on the menu screen, the apparatus shifts to the state shown in FIG. 3A. By operating a color key, the screen shifts to a desired color setting screen. On the other hand, when a color mode (expert mode) is selected on the menu screen, as shown in FIG. 5, a user can check the current adjustment state. At this time, a color state panel 102 which displays the current state appears under the control of the panel output module 623.

In the example in FIG. 5, it can be seen that red is off and blue and green are on and in this state the color density is set to 60 and the tint is set to 90. To check other states, by pressing, for example, the color key 17 mb on the remote control 72, a setting state in which blue is off and red and green are on can be checked; by pressing the color key 17 mr, a setting state in which red is off and blue and green are on can be checked; and by pressing the color key 17 mg, a setting state in which green is off and red and blue are on can be checked. To make a readjustment, by clicking a button on an edit panel 103 displayed under the control of the panel output module 623, the apparatus can shift to a readjustment mode. In the readjustment mode, an adjustment panel 100 such as that shown in FIGS. 3A to 3C is displayed. When a predetermined period of time of no operation has elapsed or when the return key 17k is operated, the apparatus shifts to a full-color image display state.

As described above, the present invention is useful for application to image signal processing apparatuses and digital television broadcast receivers. Also, the present invention is useful for application not only to television broadcast receivers but also to recording/reproducing apparatuses, set-top boxes, etc.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image signal processing apparatus comprising:
a display color set module configured to set a color limited display state according to an operation signal for selecting, the color limited display state being an off-state of at least one of color components of red, green and blue for a displaying full-color image signal; and
an image quality adjustment module configured to uniquely adjust a color limited image signal in the state of said color limited display state according to an operation signal for adjustment.

2. The image signal processing apparatus of claim 1, further comprising a display returning module configured to allow the apparatus to return to a state in which the full-color image signal containing the color components of red, green, and blue is output, after a predetermined period of time has elapsed after the adjustment by the image quality adjustment module has been completed.

3. The image signal processing apparatus of claim 1, wherein when the setting shifts, by an operation, to one in which all the color components of red, green, and blue are non-display, the display color set module does not perform this setting.

4. The image signal processing apparatus of claim 1, further comprising a message output module configured to output, when the setting performed by the display color set module shifts, by an operation, to one in which all the color components of red, green, and blue are non-display, a message indicating that this setting is invalid.

5. The image signal processing apparatus of claim 1, wherein the setting performed by the display color set module is changed by operating red, green, and blue color keys on a remote control, and by a repetitive operation of one same color key a single-color image signal corresponding to the color key repeats on and off.

6. The image signal processing apparatus of claim 1, further comprising an image display module configured to be supplied with the full-color image signal.

7. A method of controlling an image signal processing apparatus having a control module configured to control a full-color image signal to be output to an image processing module, the method comprising:
setting a color limited display state according to an operation signal for selecting, the color limited display state being an off-state of at least one of color components of red, green, and blue for a full-color image signal which is output for displaying; and
uniquely adjusting a color limited image signal in the color limited display state according to an operation signal for adjustment.
